(19) United States
(12) Patent Application Publication
(10) Pub. No.: US 2020/0099578 A1
(43) Pub. Date: Mar. 26, 2020

(54) NETWORK DEVICE UPGRADE

(71) Applicant: Hewlett Packard Enterprise Development LP, Houston, TX (US)

(72) Inventors: Mahesh Venkateshwaran, Bangalore (IN); Shanmuga Mari S, Bangalore (IN); Tarani Gaur, Bangalore (IN)

(21) Appl. No.: 16/136,703

(22) Filed: Sep. 20, 2018

(51) Int. Cl. H04L 12/24; H04W 24/02; H04W 88/10

(52) U.S. Cl. CPC H04L 41/082; H04W 48/16; H04W 88/10; H04W 24/02

(57) ABSTRACT

Example implementations relate to network deployment of devices. For example, a non-transitory computer readable medium storing instructions executable by a processing resource can determine a plurality of deployment thresholds of a plurality of devices, wherein the plurality of deployment thresholds are associated with a type of the plurality of devices. The instructions can cause the processing resource to monitor deployment data associated with the plurality of devices to identify a device with a deployment outlier. The device with the deployment outlier is a device with deployment data that is outside a deployment threshold of the device. The instructions can cause the processing resource to adjust the deployment threshold of the device based on the monitoring.

### BACKGROUND

A network device referred to as an access point (“AP”) can be a wireless networking device used to allow Wi-Fi compliant devices to connect to a wired network. An AP can connect to a router via the wired network as a standalone device. An AP can be coupled to a wired network and provide wireless access to a number of clients. A network device can be managed and/or monitored by a controller that controls automatic adjustments of power, channels, authentication, and/or security.

### BRIEF DESCRIPTION OF THE DRAWINGS

FIG. 1 illustrates an example system for network device upgrade consistent with the present disclosure.

FIG. 2 illustrates an example system for network device upgrade consistent with the present disclosure.

FIG. 3 illustrates a diagram of a flow chart method of a network device upgrade consistent with the present disclosure.

FIG. 4 illustrates an example diagram of a network device upgrade consistent with the present disclosure.

FIG. 5 illustrates an example diagram of a network device upgrade consistent with the present disclosure.

FIG. 6 illustrates a diagram of a flow chart method of a network device upgrade consistent with the present disclosure.

FIG. 7 illustrates an example method of a network device upgrade consistent with the present disclosure.

FIG. 8 illustrates an example of a non-transitory machine readable medium for network device upgrade consistent with the present disclosure.

### DETAILED DESCRIPTION

Wireless networks can provide various types of communication to multiple users wirelessly through the use of electromagnetic waves. As a result, various types of communication may be provided to multiple users without cables, wires, or other physical electric conductors to couple devices in the wireless network. Examples of the various types of communication that may be provided by wireless networks include voice communication, data communication, multimedia services, etc.

An example of a wireless network is a wireless local area network (WLAN). As used herein, ‘wireless local area network’ (WLAN) can, for example, refer to a communications network that links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network. WLANs may include multiple stations (STAs) and/or network devices referred to as access points (APs) that may communicate over a plurality of wireless channels. An STA is a device that has the capability to use the Institute of Electrical and Electronics Engineers (IEEE) 802.11 protocol. Examples of STAs include smart phones, laptops, physical non-virtualized computing devices, personal digital assistants, etc. In some examples, a STA may be a device that contains an IEEE 802.11-conformant media access control (MAC) and physical layer (PHY) interface to a wireless medium (WM).

Wireless networks such as WLANs can use one or more wireless communication technologies. For example, WLANs can use orthogonal frequency division multiplexing (OFDM). In an OFDM based wireless network, a data stream is split into multiple data substreams. Such data substreams may be sent over different OFDM subcarriers, which can be referred to as tones or frequency tones. Some wireless networks may use a single-in-single-out (SISO) communication approach, where each STA and/or AP uses a single antenna. Other wireless networks may use a multiple-in-multiple-out (MIMO) communication approach, where a STA and/or AP uses multiple transmit antennas and multiple receive antennas. WLANs such as those defined in the IEEE wireless communications standards (e.g., IEEE 802.11a, IEEE 802.11n, IEEE 802.11ac, etc.) can use OFDM to transmit and receive signals. Moreover, WLANs, such as those based on the IEEE 802.11n or IEEE 802.11ac standards, can use OFDM and MIMO.

As used herein, an AP is a networking hardware device that allows a wireless-compliant device (e.g., a STA) to connect to a network. As an example, ‘access point’ (AP) can refer to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards. An AP can include a processing resource, memory, and/or input/output interfaces, including wired network interfaces such as IEEE 802.3 Ethernet interfaces, as well as wireless network interfaces such as IEEE 802.11 Wi-Fi interfaces, although examples of the disclosure are not limited to such interfaces. An AP can include a memory resource, including read-write memory, and a hierarchy of persistent memory such as ROM, EPROM, and Flash memory

A network device such as an access point (AP) may provide connectivity with a network such as the internet to the STAs. As used herein, ‘network device’ can, for example, refer to a device that is adapted to transmit and/or receive signaling and to process information within such signaling such as a station (e.g., any data processing equipment such as a computer, cellular phone, personal digital assistant, table devices, etc.), an AP, data transfer devices (such as network switches, routers, controllers, etc.) or the like. As used herein, the term “router” can, for example, refer to a networking device that forwards data packets between networks. As used herein, the term “switch” can, for example, refer to a computer networking device that connects devices together on a network by using, for example, packet switching to receive, process and forward data to a destination device. For example, a switch can include memory, including read-write memory, and a hierarch of persistent memory such as ROM, EPROM, and Flash memory.

An AP can be coupled to a wired network and provide wireless access to a number of clients. An AP can be managed and/or monitored by a controller that controls automatic adjustments of power, channels, authentication, and/or security. A common public application of an AP can be referred to as a hotspot where a wireless client can connect to the internet independent of being aware of which particular network the wireless client is attached to. This can be beneficial for staying continually connected to the internet while moving around from location to location.

An AP can be upgraded in order to provide up-to-date wireless connectivity. In the event that an AP is being upgraded, a client accessing the AP can be disconnected and experience a lapse in service. In the instance where a plurality of APs are offering network service to a plurality of clients and the plurality of APs are upgraded at the same time, the plurality of clients can experience a lapse in network service as there may be limited and/or no APs to provide the network service. By dividing the APs into groups, the upgrade can be divided into stages and those APs not being upgraded can provide service while other APs are being upgraded. This upgrade can be controlled by a controller in control of the plurality of APs or this upgrade can be controlled by a master AP, designated by the plurality of APs. As the plurality of APs are divided into groups in order to provide a tiered approach to the upgrade, each of the groups can select a master AP to control the group.

The selection of which group to place each of the plurality of APs can be based on radio-frequency coverage and/or whether an AP neighbors another AP. As described below, by determining the groups of APs based on neighboring APs, a large number of APs may be upgraded without determining groups based on overlap coverage. The determination of overlap coverage can use up resources and take an extended period of time in relation to determining neighboring APs. The neighboring APs can be determined based on a frequency that each of the APs is using to provide the network service. As an example, two neighboring APs may use different frequencies in order to avoid using a similar frequency that may cause network information to be corrupted. In response to two APs using a same frequency, it can be determined that the two APs are not neighboring APs and the two APs could be upgraded together without loss of network coverage.

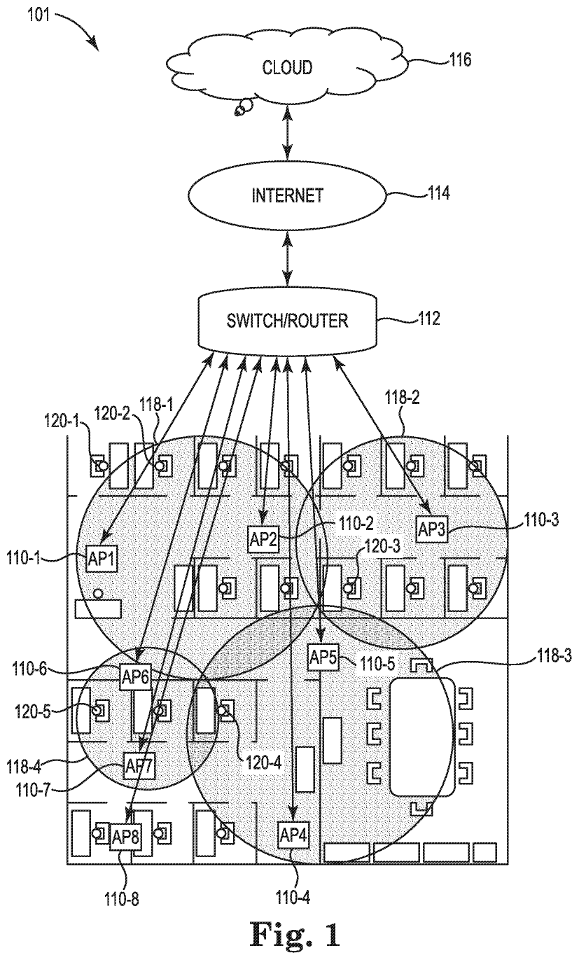

FIG. 1 illustrates an example system 101 for network device upgrade consistent with the present disclosure. As illustrated in FIG. 1, the system 101 can include a cloud 116, such as a network of remote servers hosted from the internet to store, manage, and/or process data, in contrast to a local server or a personal computer. The cloud 116 can be accessed through the internet 114 by a network device 112 (e.g., a switch, a router, etc.). The network device 112 can be in communication with a plurality of network devices (e.g., access points) 110-1 to 110-8 (hereinafter referred to collectively as network devices 110). The network devices 110 can be in communication, such as through wireless communication, with a plurality of users 120-1, 120-2, 120-3, 120-4, 120-5 (hereinafter referred to collectively as users 120).

The plurality of network devices (e.g., access points) 110 can be deployed in a network. Network deployment can refer to a process of setting up or initializing a new network device and/or computer system to make it available for use in a network or available for productive work in a live network environment for the plurality of users 120. Deployment can include processes involved in getting new software and/or hardware associated with the deployed device up and running properly in the network environment, which can include installation, configuration, running, testing, making changes, upgrading software, and/or upgrading applications, etc. As a network device (e.g., an access point) is deployed within the network, the device can be available for use. Deployment of a network device can take a particular period of time to deploy based on a number of network characteristics, a type of the device, and/or a server associated with the network device once it is within the network.

Once an access point is deployed in a network, the access point may be upgraded with software and/or application upgrades in order to improve the efficiency of the access point within the network and/or provide additional accessibility or connectivity of the access point. The plurality of network devices 110 can be upgraded in a tiered approach to avoid loss of connectivity. In contrast, in some approaches, upgrading a plurality of network devices together can result in a loss of connectivity as there may not be a network device to provide network connectivity while the plurality of network devices are re-booting with the upgraded characteristics. As will be described below, by dividing the upgrade into groups, at least one group can be re-booting while another group of network devices are providing network connectivity.

As an example, the plurality of network devices 110 can be put into groups of network devices based on whether a network device is a neighbor to another network device. Network devices can be placed in groups of network devices in order to provide a tiered upgrade approach. For example, network device 110-1 can be a neighboring network device to network device 110-2. Network device 110-1 can be in a first group of network devices while network device 110-2 can be in a second group of network devices. In this way, one of network device 110-1 and network device 110-2 will be providing network connectivity while the other is being upgraded and rebooted. Likewise, network device 120-1 neighbors network devices 110-6 and 110-7. Network device 110-2 neighbors network devices 110-1, 110-3, and 110-5. Network device 110-5 neighbors network devices 110-4, 110-2, and 110-3. Network device 110- neighbors network devices 110-7 and 110-8.

In order to provide network connectivity without a loss of network connectivity, network devices 110-1, 110-3, 110-4, and 110-7 can be put in the first group of network devices and network devices 110-2, 110-5, 110-6, and 110-8 can be put in a second group of network devices. The first group of network devices can be upgraded while the second group of network devices continues to provide network connectivity. Likewise, the second group of network devices can be upgraded while the first group of network devices provides network connectivity. While two groups are illustrated and described, examples are not so limited. Any number of groups can be created for upgrade and any number of groups can be upgraded together while other groups are providing network connectivity.

Neighboring network devices, due to their proximity, can provide a similar network coverage area. For example, network device 110-1 and network device 110-2 can provide a network coverage area 118-1. Network device 110-3 can provide a network coverage area 118-2. Network devices 110-4 and 110-5 can provide network coverage area 118-3. Network devices 110-6 and 110-7 can provide network coverage area 118-4. In this way, network devices can be placed in groups such that another network device can provide network connectivity for the users in the network coverage area associated with a network device.

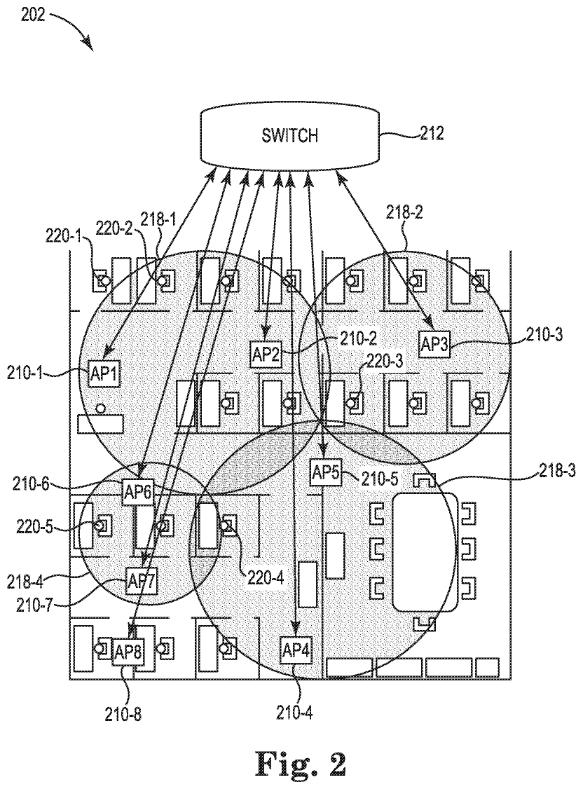

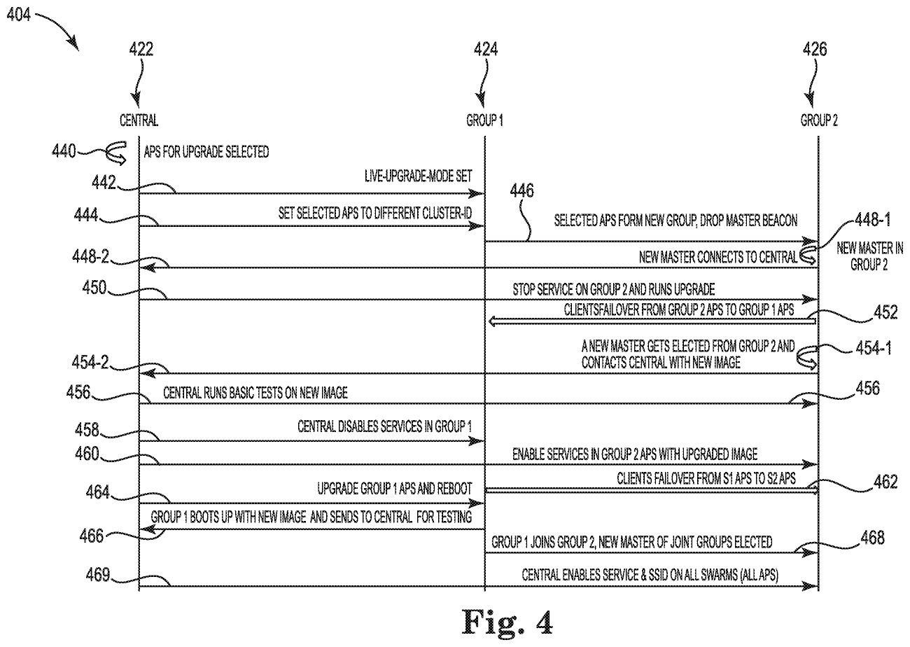

As illustrated in FIG. 1, a cloud 116 can include and/or be in communication with a central system, such as central 422 in FIG. 4. In this way, the central system can be in communication with the plurality of network devices 110 in order to perform an upgrade, in contrast to what is illustrated in FIG. 2, where a switch, such as switch 212, is in communication with the plurality of network devices 210 and is upgraded independent of communication from a central system.

FIG. 2 illustrates an example system 202 for network device upgrade consistent with the present disclosure. As illustrated in FIG. 2, the system 202 can include a network device (e.g., a switch, a router, etc.) 212 in communication with a plurality of network devices (e.g., access points) 210-1 to 210-8 (hereinafter referred to collectively as network devices 210). The network devices 210 can be in communication, such as through wireless communication, with a plurality of users 220-1 to 220-5 (hereinafter referred to collectively as users 220).

The plurality of network devices 210 can designate a master network device, such as network device 210-1, that controls the other network devices of the plurality of network devices 210. In this way, the plurality of network devices 210 can upgrade in the absence of a central system for controlling the upgrade. As an example, the master network device 210-1 can communicate with the other network devices 210-2 to 210-8 to designate groups of network devices and to upgrade those groups. The groups can be designated based on which of the network devices are neighbor network devices of other network devices. The determination of whether network devices are neighbors can be based on an analysis of which bands and/or frequencies each of the network devices 210 are using to provide network connectivity.

As an example, a radiofrequency (RF) band (e.g., a b/g band) can operate on 3 channels, such as channels 1, 6, and 11. A network device may not use the same channel as a neighboring network device. For example, as illustrated in FIG. 2, network device 210-1 can operate using channel 1 while network device 210-2 can operate using channel 6. Since network device 210-1 uses a different channel than network device 210-2, the network devices, 210-1 and 210-2, can be designated as neighboring network devices and would not be placed in a same network device group. Therefore, network device 210-1 can be placed in a first group while network device 210-2 can be placed in a second group. This would prevent network devices 210-1 and 210-2 from being upgraded at the same time and would allow either of them to provide network connectivity while the other is being upgrade.

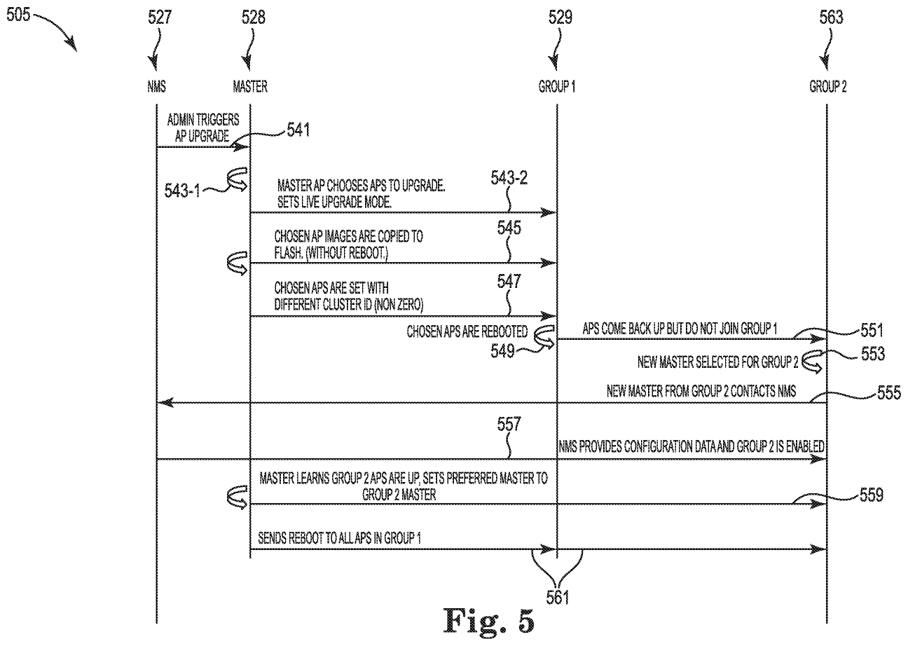

The first group of network devices can include network devices 210-1, 210-3, 210-4, and 210-7 and the second group of network devices can include network devices 210-2, 21-5, 210-6, and 210-8. While the first group is being upgrade, the second group can provide network connectivity. Likewise, while the second group is being upgraded, the first group can provide network connectivity. As will be described further below in association with FIG. 5, the plurality of network devices 210 can be upgraded in the absence of control from a central system. As an example, a master network device can control the plurality of network devices 210 to perform an upgrade.

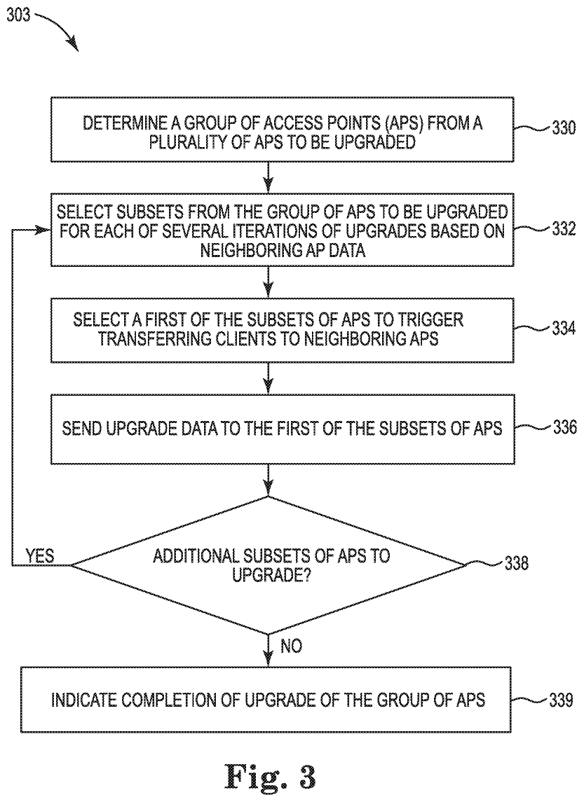

FIG. 3 illustrates a diagram of a flow chart method 303 of a network device upgrade consistent with the present disclosure. The method 303 can include, at block 330, determining a group of access points (APs) from a plurality of access points to be upgraded. As an example, a group of APs (such as APs 210-1 to 210-8 in FIG. 2) can be selected to be upgraded from a plurality of APs (such as additional APs than are illustrated in FIG. 2).

The method 303 can include, at block 332, selecting subsets from the group of APs to be upgraded for each of several iterations of upgrades based on neighboring AP data. A first group of APs can include a subset of the group of access points 210, such as first group of APs 210-1, 210-3, 210-4, and 210-7 in FIG. 2. A second group of APs can include an additional subset of the group of access points 210, such as second group of APs 210-2, 210-5, 210-6, and 210-8.

The method 303 can include, at block 334, selecting a first of the subsets of APs to trigger transferring clients (e.g., users) to neighboring APs. The first subset of APs can receive an indication to transfer the clients from a master AP of the first subset of APs. In response to receiving the indication to transfer, the first subset of APs can transfer their clients receiving network connectivity from the first subset of APs to an additional subset of APs. As an example, an AP (such as AP 210-1 in FIG. 2) can be designated a master AP and can indicate to transfer clients receiving network connectivity from the first group (such as APs 210-1, 210-3, 210-4, and 210-7) to the second group (such as APs 210-2, 210-5, 210-6, and 210-8), resulting in the second group of APs providing network connectivity to the clients and the first group of APs no longer providing network connectivity.

The method 303 can include, at block 336, sending upgrade data to the first of the subsets of APs. The first subset of APs can upgrade their data with the upgrade data and reboot.

The method 303 can include, at block 338, determining whether additional subsets of APs are to be upgraded. In response to additional subsets of APs waiting to be upgraded (“YES”), additional selection (repeating block 332) of additional subsets from the group of APs to be upgraded for each of several iterations of upgrades based on neighboring AP data can be performed. In response to no additional subsets of APs yet to be upgraded (“NO”), the method 303 can include, at block 339, indicating completion of the upgrade of the group of APs.

FIG. 4 illustrates an example diagram 404 of a network device upgrade consistent with the present disclosure. The diagram includes a central system 422 that can communicate with a first group (“Group 1”) of access points (APs) 424 and a second group (“Group 2”) of access points (APs) 426. Central 422 can be a system in communication with the first group 424 and second group 426 of APs through a cloud (e.g. cloud 116 in FIG. 1) and/or through the internet (e.g., internet 114 in FIG. 1). Central 422 can be a wireless network management cloud service. Central 422 can select, at 440, which APs to be upgraded.

The first group of APs 424 can designate a master beacon that controls the first group of APs 424. The master beacon can be a controller at Central 422 in communication with the first group of APs 424 or an AP within the first group of APs 424 that is designated as a master AP. Central 422 can set, at 442, a live-upgrade mode for a first group of APs 424. Central 422 can set, at 444, selected APs (e.g., a subset of the APs in the first group of APs 424) to a different cluster-ID. The selected APs, at 446, can form a new group (e.g., the second group of APs 426) and drop a master beacon that controls the first group of APs. At 448-1, a new master beacon can be designated for control of the second group of APs 426. The new master beacon can be a master AP selected from the APs within the second group of APs. At 448-2, the new master beacon can connect to Central 422.

At 450, Central 422 can send a message to stop service being provided by the second group of APs and indicate to run the upgrade on the second group of APs 426. At 452, the clients can failover from receiving network connectivity from the second group of APs 426 and connect to the first group of APs 424 to receive network connectivity. At 454-1, the new master of the second group of APs 426 creates a new image associated with the upgrade and, at 454-2, the new master of the second group of APs 426 contacts Central 422 with the new image. At 456, Central 422 runs a basic test on the new image to determine whether the upgrade of the second group of APs 426 was successful. At 458, Central 422 indicates to disable network connectivity services to the first group (“Group 1”) of APs 424. At 460, Central 422 enables network connectivity services in the second group (“Group 2” of APs 426 with the upgraded image.

At 462, the clients failover from receiving network connectivity services from the first group (“S1”) of APs 424 to receiving connectivity services from the second group (“S2”) of APs 426. At 464, the first group of APs 424 are upgraded and rebooted. At 466, the first group of APs 424 are booted up with the new image and sends the new image to Central 422 for testing to determine whether the upgrade was successful. At 468, the first group of APs (“Group 1”) 424 joins the second group of APs (“Group 2”) 426 and a new master of the joint group (including both the first group of APs and the second group of APs now both in the second group of APs 426) is elected. At 469, Central enables network connectivity services and SSID on all swarms (or groups) of APs (e.g., all APs selected for upgrade). At this point, Group 1 424 has been terminated as all APs selected for upgrade are in Group 2 426 and all selected APs have been upgraded and network connectivity has been maintained with the clients throughout the upgrade performance.

FIG. 5 illustrates an example diagram 505 of a network device upgrade consistent with the present disclosure. The example diagram 505 includes a network management system (NMS) 527, a master access point (AP) 528, a first group of access points (APs) 529, and a second group of APs 563. The NMS 527 can be an application or set of applications that lets network administrators manage a network's independent components within a larger network management framework. The NMS 527 may be used to monitor both software and/or hardware components in a network. The NMS 527 can record data from a network's remote points to carry out central reporting to a system administrator. The NMS 527 can be used for network device discovery, network device monitoring, network performance analysis, network device management, and/or intelligent notifications, or customizable alerts. The master AP 528 can be elected or selected from within a group of APs to be master over the rest of the APs within the group of APs.

The example diagram 505 can include, at 541, an administrator, through the NMS 527, triggering an AP upgrade. At 543-1, a master AP 528 over a plurality of APS can choose which APs of a plurality of APs to upgrade. At 543-2, the master AP 528 sets a live upgrade mode for the chosen APs for upgrade, which in turn are within the first group of APs (“Group 1”) 529 to be upgraded. At 545, the chosen AP images of the upgrade associated with the chosen APs (e.g., Group 1 529) are copied to flash, and the first group of APs 529 are not rebooted. At 547, a group of APs within the APs for upgrade are chosen and set with a different cluster ID (e.g., a non-zero cluster ID). As an example, a portion of the APs in the first group of APs 529 are chosen to be set with a different cluster ID. While the examples herein illustrated two groups of APs, examples are not so limited. For example, any number of cluster IDs can be associated with any number of groups of APs in order to upgrade each of the groups of APs associated with a particular cluster ID in a tiered approach.

At 549, the APs chosen to be set with the different cluster ID are rebooted. At 551, the rebooted APs come back up but do not join Group 1 529 as the rebooted APs have a different cluster ID, which now associates the rebooted APs as a second group of APs 563. The second group of APs 563 can be tested by the master AP 528 and/or by NMS 527. At 553, a new master is selected from Group 2 563. At 555, the new master of Group 2 563 contacts NMS 527. At 557, NMS 527 provides configuration data and Group 2 563 is enabled to provide network connectivity to a plurality of users. At 559, the master 528 learns that Group 2 563 APs are up and sets the new master of Group 2 563 as the new master of Group 1 529 as well. At 561, the master 528 reboots all APs in Group 1 529, which causes Group 1 529 to join the APs of Group 2 563, eliminating Group 1 529 by transferring APs of Group 1 529 to Group 2 563. The first group of APs 529 can be tested by either of a master AP of the second group of APs 563 and/or the NMS 527 in order to verify that the upgrade was successful. At this point, all chosen APs have been upgraded and are in a same group of APs (e.g., Group 2 563.

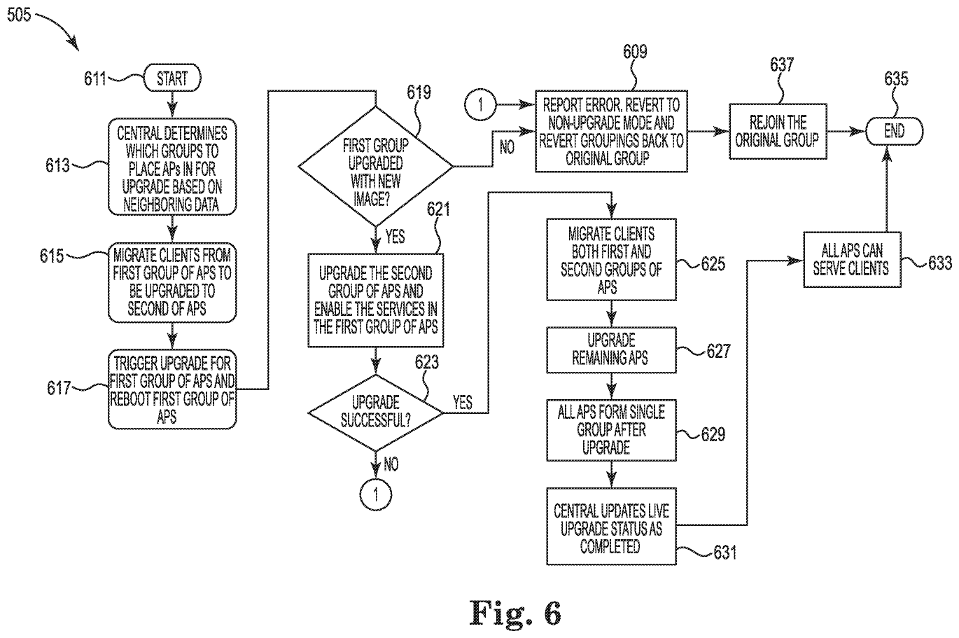

FIG. 6 illustrates a diagram of a flow chart method 505 of a network device upgrade consistent with the present disclosure. The flow chart method 505 starts, at 611, and begins by a central system determining, at 613, which groups to place APs in for upgrade based on neighboring data. At 615, clients can be migrated from a first group of APs to be upgraded to a second group of APs. At 617, an upgrade can be triggered for the first group of APs and a reboot of the first group of APs can be performed. At 619, a determination of whether the first group of APs has been upgraded with a new image can be performed. In response to a determination that the first group of APs have been upgraded (YES), at 621, an upgrade of the second group of APs and enablement of network services by the first group of APs can be performed. In response to a determination that the first group of APs did not upgrade with the new image (NO), at 609, an error can be reported and a reversion to the non-upgraded mode can be performed along with a reversion of the groupings of APs back to the original group of APs. Subsequent to these reversions, the first group of APs can rejoin, at 637, the original group of APs and the upgrade process can end, at 635.

Subsequent to the upgrade of the second group of APS (e.g., at 621), a determination, at 623, of whether the upgrade of the second group of APs was successful can be determined. In response to the upgrade of the second group of APs being unsuccessful, an error can be reported, at 609, and a reversion to a non-upgrade mode and a reversion of the AP groupings back to the original group can be performed, followed by a rejoining, at 637, of the second group of APs to the original group and the upgrade process ending, at 635.

In response to the upgrade of the second group of APs being successful, clients can be migrated, at 625, to both the first group of APs and the second group of APs in order to receive network connectivity from both the first and the second group of APs. In response to there being additional APs that have not been updated, remaining APs can be upgraded, at 627. In response to all APs to receive the upgrade being upgraded, all APs form a single group, at 629, subsequent to the upgrading. At 631, the central system can update live upgrade status for all the APs as completed. At 633, all APs can serve clients as a single group and the upgrade process can end, at 635.

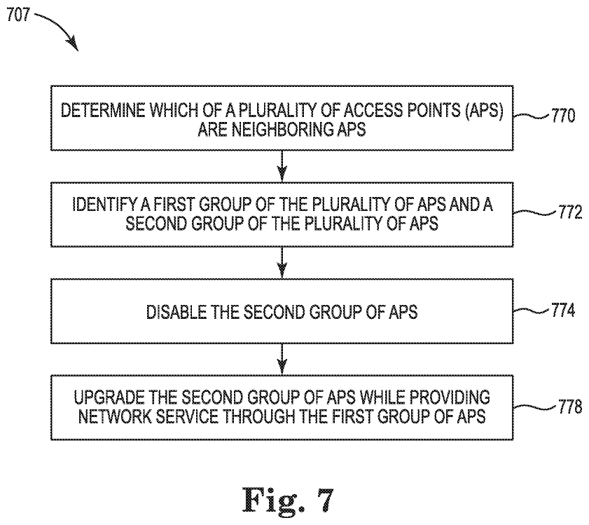

FIG. 7 illustrates an example method 707 of a network device upgrade consistent with the present disclosure. At 770, the method 707 can include determining which of a plurality of access points (APs) are neighboring APs. At 772, the method can include identifying a first group of the plurality of APs and a second group of the plurality of APs. At 774, the method 707 can include disabling the second group of APs. At 778, the method 707 can include upgrading the second group of APs while providing the network service through the first group of APs. The method 707 can include, transferring clients from receiving network connectivity service from the second group of APs to receiving network connectivity service from the first group of APs.

The method 707 can include, subsequent to upgrading the second group of APs, transferring network connectivity service from the first group of APs to the second group of APs and disabling service from the first group of APs. The method 707 can include, subsequent to disabling the service from the first group of APs, upgrading the first group of APs. The method 707 can include, subsequent to upgrading both the first group of APs and the second group of APs, providing network connectivity service through both the first group of APs and the second group of APs.

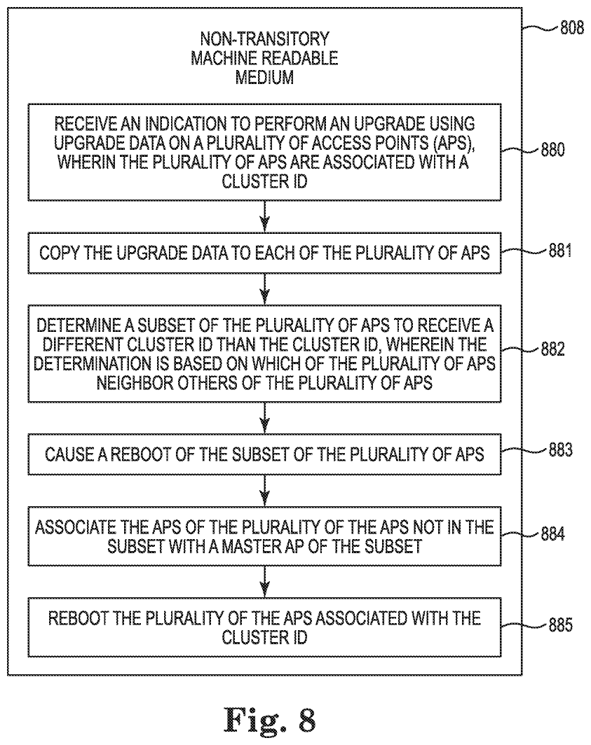

FIG. 8 illustrates a diagram of an example of a non-transitory machine readable medium 808 for network device upgrade consistent with the present disclosure. A processing resource (not illustrated) may execute instructions stored on the non-transitory machine readable medium 808. The non-transitory machine readable medium 808 may be any type of volatile or non-volatile memory or storage, such as random access memory (RAM), flash memory, read-only memory (ROM), storage volumes, a hard disk, or a combination thereof. The example medium 808 may store instructions 880 to 885 executable by a processing resource to upgrade a plurality of APs.

In some examples, the example medium 808 may store instructions 880 executable by a processing resource to receive an indication to perform an upgrade using upgrade data on a plurality of access points (APs). The plurality of APs can be associated with a cluster ID. The cluster ID can associate the plurality of APs with a particular group of APs.

In some examples, the example medium 808 may store instructions 881 executable by the processing resource to copy the upgrade data to each of the plurality of APs. In some examples, the example medium 808 may store instructions 882 executable by the processing resource to determine a subset of the plurality of APs to receive a different cluster ID than the cluster ID. The determination of the subset can be based on which of the plurality of APs neighbor others of the plurality of APs.

In some examples, the example medium 808 may store instructions 883 executable by the processing resource to cause a reboot of the subset of the plurality of APs. The subset of the plurality of APs can reboot with the upgrade data installed on the subset of the plurality of APs. As the subset of the plurality of APs reboot, the subset of APs can be associated with an additional group of APs due to the different cluster ID of the subset of APs. The subset of APs can be enabled to provide network connectivity while the APs associated with the original cluster ID can be disabled and prevented from providing network connectivity.

In some examples, the example medium 808 may store instructions 884 executable by the processing resource to associate the APs of the plurality of APs not in the subset with a master AP of the subset. As the APs associated with the cluster ID are rebooted, the APs associated with the cluster ID will be associated with the master AP of the subset of APs and all of the APs will be upgraded and in the same group. In some examples, the example medium 808 may store instructions 885 executable by the processing resource to reboot the plurality of the APs associated with the cluster ID, thereby placing all APs in the same group and completing the upgrade of the plurality of APs.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Further, as used herein, “a number of” an element and/or feature can refer to one or more of such elements and/or features.

What is claimed:

1. A method, comprising:
determining, by a network device, which of a plurality of access points (APs) that provide network service are neighboring APs, wherein neighboring APs comprise APs with overlapping radio frequency (RF) coverage;
identifying, based on the determined neighboring APs, a first group of the plurality of access points (APs) and a second group of the plurality of APs, wherein the first group and the second group each comprise non-neighboring APs;
disabling the second group of APs; and
upgrading the second group of APs while providing the network service through the first group of APs;
wherein each AP of the plurality of APs is a member of only one of the first group and the second group.

2. The method of claim 1, comprising:
enabling the second group of APs; and
disabling the first group of APs' ability to provide the network service.

3. The method of claim 2, comprising upgrading the first group of APs while providing the network service through the second group of APs.

4. The method of claim 1, wherein identifying the first group of APs and the second group of APs is based on identifying a same frequency used by each of the plurality of APs.

5. The method of claim 4, wherein identifying the first group of APs and the second group of APs comprises determining that a first AP using a particular frequency and a second AP using the particular frequency are not neighboring APs.

6. The method of claim 5, wherein the first AP and the second AP are identified as in the first group of APs based on the determination that the first AP and the second AP are not neighboring APs.

7. The method of claim 4, wherein identifying the first group of APs and the second group of APs comprises determining that a first AP using a first frequency and a second AP using a second frequency are neighboring APs.

8. The method of claim 7, wherein the first AP is identified as in the first group and the second AP is identified as in the second group based on the determination that the first AP and the second AP are neighboring APs.

9. A network device, comprising:
a processor; and
a non-transitory machine readable medium storing instructions executable by the processor to:
receive an indication to perform an upgrade using upgrade data on a plurality of access points (APs), wherein the plurality of APs are associated with a cluster ID that indicates the plurality of APs are in a first group of APs;
copy the upgrade data to each of the plurality of APs;
determine a subset of the plurality of APs to receive a different cluster ID than the cluster ID, wherein the determination is based on which of the plurality of APs neighbor others of the plurality of APs;
cause a reboot of the subset of the plurality of APs, wherein subsequent to the reboot the subset of the plurality of APs implement the upgrade data and are associated with a second group of APs;
associate the APs of the plurality of APs not in the subset of the plurality of APs with a master AP of the subset of the plurality of APs; and
reboot the plurality of APs associated with the cluster ID, wherein, subsequent to the reboot of the plurality of APs associated with the cluster ID, the plurality of APs associated with the cluster ID implement the upgrade data.

10. The network device of claim 9, wherein the network device is one of the plurality of APs.

11. The network device of claim 9, wherein the subset of the plurality of APs associated with the second group of APs neighbor the plurality of APs still associated with the cluster ID.

12. The network device of claim 9, wherein the instructions are executable by the processor to perform operations to upgrade the plurality of APs in an absence of a controller.

13. The network device of claim 9, wherein the indication to perform the upgrade is received from a network management suite (NMS).

14. A system, comprising:
a plurality of access points (APs); and
a network device, the network device comprising:
a processor; and
a non-transitory machine readable medium storing instructions executable by a processor to:
determine a first group of the plurality of APs and a second group of the plurality of APs to upgrade based on which of the plurality of APs are neighboring APs;
disable network service provided by the second group of APs;
failover clients receiving the network service from the second group of APs to receive the network service from the first group of APs;
upgrade the second group of APs;
disable the network service provided by the first group of APs; and
upgrade the first group of APs.

15. The system of claim 14, comprising instructions executable by the processor to, subsequent to the upgrade of the first group of APs, re-enable the first group of APs to provide the network service.

16. The system of claim 14, wherein the plurality of APs are associated with a cluster ID, and one of the plurality of APs is a master AP of the plurality of APs.

17. The system of claim 14, comprising instructions executable by the processor to, in response to determining the second group of the plurality of APs, designate a cluster ID for the second group of APs.

18. The system of claim 17, comprising instructions executable by the processor to, subsequent to the upgrade of the first group of APs, associate the first group of APs with the cluster ID already designated for the second group of APs.

19. The system of claim 14, wherein the second group of APs determines a master AP over other APs in the second group.

20. The system of claim 19, wherein the master AP communicates with the processor to provide an image to test the upgrade of the second group of APs.
